(19) United States
(12) Patent Application Publication
(10) Pub. No.: US 2009/0027485 A1
(43) Pub. Date: Jan. 29, 2009

(54) Automatic Monitoring of a Call Participant's Attentiveness

(75) Inventors: George William Erhart, Loveland, CO (US); Valentine C. Matula, Granville, OH (US); David Joseph Skiba, Golden, CO (US)

Correspondence Address: Avaya;DEMONT & BREYER, LLC, 100 COMMONS WAY, STE 250, HOLMDEL, NJ, 07733, US

(73) Assignee: AVAYA TECHNOLOGY LLC, Basking Ridge, NJ (US)

(21) Appl. No.: 11/828,579

(22) Filed: Jul. 26, 2007

(51) Int. Cl. H04N 7/173

(52) U.S. Cl. 348/14.12; 348/E09.001; 340/573.1

(57) ABSTRACT

A system is disclosed that enables a first call participant, such as an agent at a call center, to receive feedback about his attentiveness towards a second call participant while on a video call. Using the real-time image of the first call participant while on a video call, as well as additional information, the system of the illustrative embodiment evaluates one or more facial characteristics of the first participant, such as eye gaze; accumulates a record of predetermined, attentiveness-related conditions having been met; and notifies the first participant, or some other person such as the participant's supervisor, of the participant's attentiveness patterns.

### FIELD OF THE INVENTION

The present invention relates to telecommunications in general, and, more particularly, to monitoring the attentiveness of, in particular the eye gaze of, a video-call participant.

### BACKGROUND OF THE INVENTION

A call center is a centralized office used for the purpose of handling a large volume of telephone calls. For example, a call center can be operated by an enterprise to process incoming calls from customers seeking product support or other information, in which the calls are directed to service agents who can then assist the customers. An enterprise can use a call center for outgoing calls as well.

FIG. 1 depicts telecommunications system 100 in the prior art, which features a call center. Telecommunications system 100 comprises telecommunications terminals 101-1 through 101-M, wherein M is a positive integer; telecommunications network 105; private branch exchange (PBX) 110; telecommunications terminals 111-1 through 111-N, wherein N is a positive integer; and interactive voice response (IVR) system 120, the depicted elements being interconnected as shown. The call center itself comprises elements 110, 111-1 through 111-N, and 120.

Calling telecommunications terminal 101-m, where m has a value between 1 and M, is one of a telephone, a notebook computer, a personal digital assistant (PDA), etc. and is capable of placing and receiving calls via telecommunications network 105.

Telecommunications network 105 is a network such as the Public Switched Telephone Network [PSTN], the Internet, etc. that carries calls to and from telecommunications terminal 101, private branch exchange 110, and other devices not appearing in FIG. 1. A call might be a conventional voice telephony call, a video-based call, a text-based instant messaging (IM) session, a Voice over Internet Protocol (VoIP) call, and so forth.

Private branch exchange (PBX) 110 receives incoming calls from telecommunications network 105 and directs the calls to IVR system 120 or to one of a plurality of telecommunications terminals within the enterprise (i.e., enterprise terminals 111-1 through 111-N), depending on how exchange 110 is programmed or configured. For example, in an enterprise call center, exchange 110 might comprise logic for routing calls to service agents' terminals based on criteria such as how busy various service agents have been in a recent time interval, the telephone number called, and so forth.

Additionally, exchange 110 might be programmed or configured so that an incoming call is initially routed to IVR system 120, and, based on caller input to system 120, subsequently redirected back to exchange 110 for routing to an appropriate telecommunications terminal within the enterprise. Possibly, exchange 110 might queue each incoming call if all agents are busy, until the queued call can be routed to an available agent at one of enterprise terminals 111-1 through 111-N. Exchange 110 also receives outbound signals from enterprise terminals 111-1 through 111-N and from IVR system 120, and transmits the signals on to telecommunications network 105 for delivery to a caller's terminal.

Enterprise telecommunications terminal 111-n, where n has a value between 1 and N, is typically a deskset telephone, but can be a notebook computer, a personal digital assistant (PDA), and so forth, and is capable of receiving and placing calls via telecommunications network 105.

Interactive voice response (IVR) system 120 is a data-processing system that presents one or more menus to a caller and receives caller input (e.g., speech signals, keypad input, etc.), as described above, via private branch exchange 110. IVR system 120 is typically programmable and performs its tasks by executing one or more instances of an IVR system application. An IVR system application typically comprises one or more scripts that specify what speech is generated by IVR system 120, what input to collect from the caller, and what actions to take in response to caller input. For example, an IVR system application might comprise a top-level script that presents a main menu to the caller, and additional scripts that correspond to each of the menu options (e.g., a script for reviewing bank account balances, a script for making a transfer of funds between accounts, etc.).

When an interactive voice response system also has video response capability, one or more of the scripts can play back a video response to the caller. The video response might comprise a pre-recorded image of a human agent, who appears to be addressing the caller. Because the image is pre-recorded, the human agent can be made to appear professional and attentive to the caller. This is in contrast to live video calls, in which some agents do not present themselves well to a caller. For example, this can happen merely because of a few bad habits that, while not apparent on a voice-only call, become immediately apparent on a video call. The end result is that the caller perceives the agent as being inattentive.

### SUMMARY OF THE INVENTION

The system of the present invention enables a first call participant, such as an agent at a call center, to receive feedback about his attentiveness towards a second call participant while on a video call. Using the real-time image of the first call participant while on a video call, as well as additional information, the system of the illustrative embodiment evaluates one or more facial characteristics of the first participant, such as eye gaze; accumulates a record of predetermined, attentiveness-related conditions having been met; and notifies the first participant, or some other person such as the participant's supervisor, of the participant's attentiveness patterns.

In particular, the system of the illustrative embodiment first receives a real-time image of a first call participant of a video call. The first participant is in video communication with the second call participant of the video call. The system also receives vocal communication from the first and second participants, as well as a real-time image of the second participant.

Next, the system evaluates whether a predetermined condition has been met, where the condition is related to the attentiveness of the first participant. For example, the condition can be related to the first participant having too little eye contact with the other party, having too much eye contact with the other party, staring at a particular part of the screen, and so forth. The evaluation is based on a facial characteristic, such as eye gaze, of the image of the first participant. In some embodiments, the evaluation is also based on at least one of i) the vocal communication received from the first participant, ii) the vocal communication received from the second participant, iii) the gender of the second participant, and iv) some other characteristic of the second participant.

The system then notifies the first participant or some party not on the call about the condition having been met. For example, the notification can be a warning that the first participant is not maintaining proper eye contact with the second participant.

In some embodiments, the system of the illustrative embodiment determines at least one characteristic of the second participant on the video call, such as the participant's gender. The characteristic is then used in the attentiveness evaluation, such as to correlate particular types of attentiveness patterns of the first participant with the characteristic of the second participant.

The illustrative embodiment of the present invention comprises: receiving an image of a first call participant of a video call, the first call participant being in video communication with a second call participant of the video call; evaluating whether a predetermined condition has been met based on a facial characteristic of the image; and when the condition has been met, transmitting a signal that is based on the condition having been met.

### BRIEF DESCRIPTION OF THE DRAWINGS

FIG. 1 depicts telecommunications system 100 in the prior art.

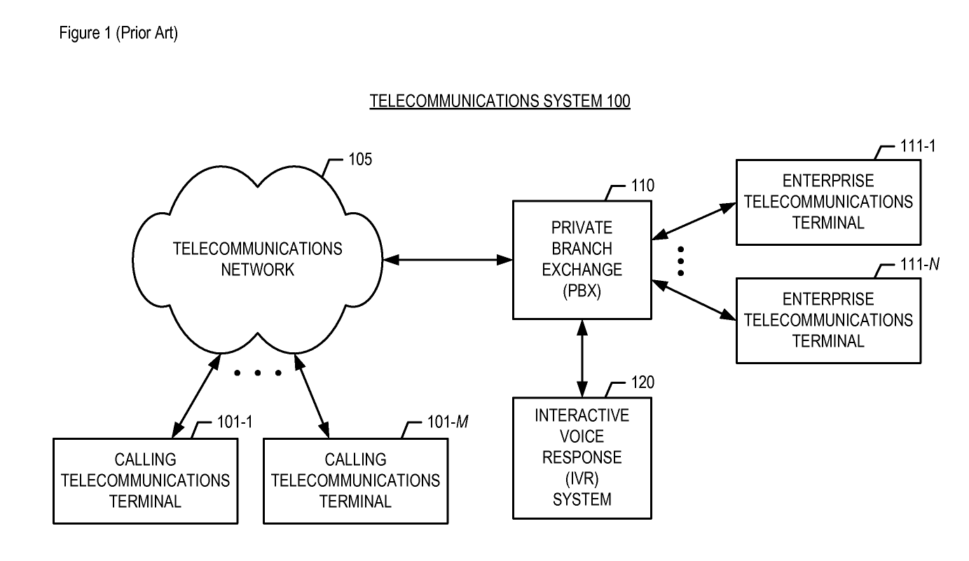

FIG. 2 depicts telecommunications system 200, in accordance with the illustrative embodiment of the present invention.

FIG. 3 depicts a flowchart of the salient tasks of interactive voice and video response (IVVR) system 220 in telecommunications system 200.

### DETAILED DESCRIPTION

The following terms are defined for use in this Specification, including the appended claims:
The term “call,” and its inflected forms, is defined as an interactive communication involving one or more telecommunications terminal (e.g., “phone”, etc.) users, who are also known as “parties” to the call. A video call is featured in the illustrative embodiment of the present invention, in which the image of at least one of the call parties is transmitted to another call party. As those who are skilled in the art will appreciate, in some alternative embodiments, a call might be a traditional voice telephone call, an instant messaging (IM) session, and so forth. Furthermore, a call can involve one or more human call parties or one or more automated devices, alone or in combination with each other.
The term “image,” and its reflected forms, is defined as a reproduction of the likeness of some subject, such as a person or object. An image can be that of a still subject or moving subject, and the image itself can be fixed or changing over time. When it is received or transmitted, such as in a computer file or in a video stream, the image is represented by a signal. The creation of the signal can involve analog signal processing, as is the case with standard television or other analog video systems, or digital signal processing, as is the case with high-definition television or other video systems that feature digital compression of images.

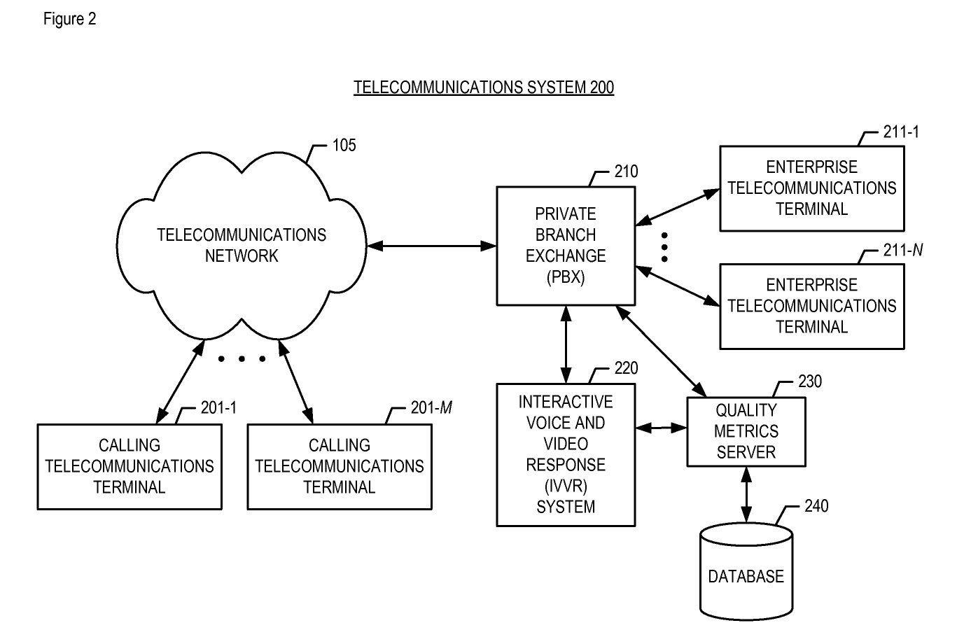

FIG. 2 depicts telecommunications system 200, which features a call center, in accordance with the illustrative embodiment of the present invention. Telecommunications system 200 comprises calling telecommunications terminals 201-1 through 201-M, wherein M is a positive integer; telecommunications network 105; private branch exchange (PBX) 210; enterprise telecommunications terminals 211-1 through 211-N, wherein N is a positive integer; interactive voice and video response system 220; quality metrics server 230; and database 240, the depicted elements being interconnected as shown. The call center itself comprises elements 210, 211-1 through 211-N, 220, 230, and 240.

Calling telecommunications terminal 201-m, where m has a value between 1 and M, is a device that is capable of originating or receiving calls, or both. For example, terminal 201-m can be one of a telephone, a notebook computer, a personal digital assistant (PDA), and so forth. Terminals 201-1 through 201-M can be different from one another, such that terminal 201-1 can be a desk set, terminal 201-2 can be a cell phone, terminal 201-3 can be a softphone on a notebook computer, and so forth.

Terminal 201-m handles calls via telecommunications network 105 and is capable of exchanging video, voice, and call processing-related signals with one or more other devices, such as terminal 211-n through private branch exchange 210. To this end, terminal 201-m exchanges one or more of Internet Protocol (IP) data packets, Session Initiation Protocol (SIP) messages, Voice over IP (VoIP) traffic, and stream-related messages (e.g., Real Time Streaming Protocol [RTSP] messages, etc.) with private branch exchange 210.

In order to handle video signals with its user, terminal 201-m comprises a video camera and display, in addition to comprising other interfaces with its user such as a microphone, speaker, and keypad or keyboard. It will be clear to those skilled in the art how to make and use terminal 201-m.

Private branch exchange (PBX) 210 is a data-processing system that provides all of the functionality of private branch exchange 110 of the prior art. In addition to handling conventional telephony-based signals, exchange 210 is also capable of exchanging Internet Protocol (IP) data packets, Session Initiation Protocol (SIP) messages, Voice over IP (VoIP) traffic, and stream-related messages (e.g., Real Time Streaming Protocol [RTSP] messages, etc.) with terminals 201-1 through 201-M and terminals 211-1 through 211-N.

Exchange 210 is further capable of communicating with interactive voice and video response system 220. Exchange 210 and system 220 can coordinate media signal transmissions on a call-by-call basis, or exchange 210 can feed system 220 the media signals from some or all of the calling parties. In accordance with the illustrative embodiment, for a given call, exchange 210 transmits to system 220 the image signal of the call agent of terminal 211-n for the purpose of evaluating that image signal for the call agent's level of attentiveness. In some embodiments, exchange 210 also receives media signals from system 220 for transmission to the terminals. Exchange 210 also receives signals such as status information from system 220, based on the evaluation performed by system 220.

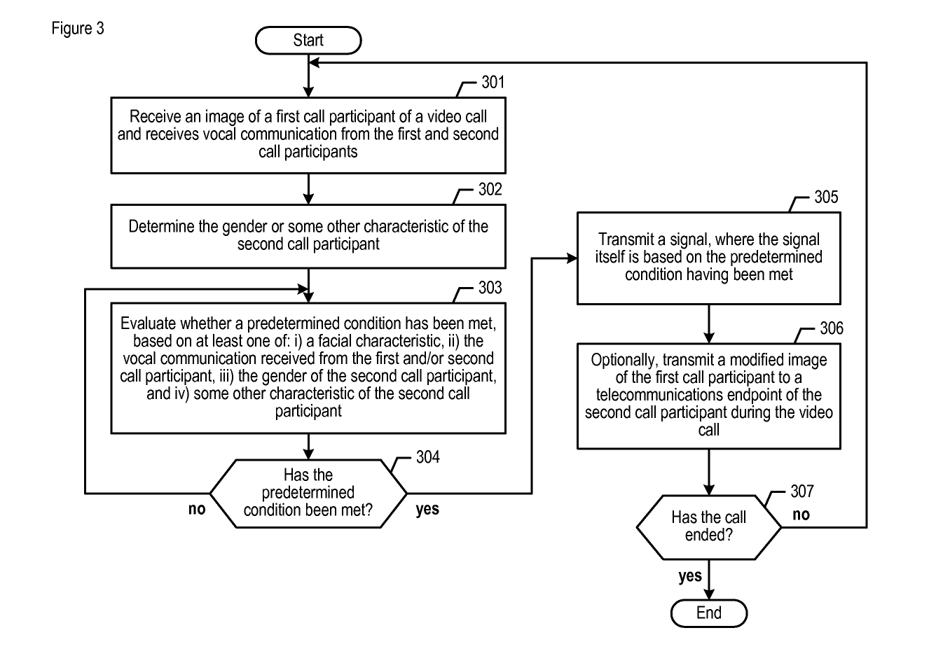

In some embodiments, exchange 210 is also capable of receiving quality metrics (i.e., attentiveness information for call agents, described with respect to FIG. 3) from quality metrics server 230, of forwarding attentiveness information to the agents' terminals, and of transmitting signals related to attentiveness to quality metrics server 230. It will be clear to those skilled in the art, after reading this specification, how to make and use exchange 210.

Enterprise telecommunications terminal 211-n, where n has a value between 1 and N, is a device that is capable of originating or receiving calls, or both. In accordance with the illustrative embodiment, terminal 211-n is a workstation softphone at a call center; in some alternative embodiments, however, terminal 211-n can be one of a telephone, a notebook computer, a personal digital assistant (PDA), and so forth. As those who are skilled in the art will appreciated, terminals 211-1 through 211-N can be different from one another.

Terminal 211-n handles calls via exchange 210 and is capable of exchanging video, voice, and call processing-related signals with one or more other devices, such as terminal 201-m through network 105. To this end, terminal 211-n exchanges one or more of Internet Protocol (IP) data packets, Session Initiation Protocol (SIP) messages, Voice over IP (VoIP) traffic, and stream-related messages (e.g., Real Time Streaming Protocol [RTSP] messages, etc.) with private branch exchange 210.

In order to handle video signals with its user, terminal 211-n comprises a video camera and display, in addition to comprising other interfaces with its user such as a microphone, speaker, and keypad or keyboard. It will be clear to those skilled in the art how to make and use terminal 211-n.

Interactive voice and video response (IVVR) system 220 is a data-processing system that provides all the functionality of interactive voice response system 120 of the prior art. System 220 is further capable of performing the tasks of FIG. 3, described below. In performing those tasks for a given call, system 220 receives an image signal of a call agent from exchange 210, evaluates whether a predetermined condition has been met with respect to the received image signal, and transmits a resultant signal (e.g., a status signal, etc.) to either exchange 210 or server 230. System 220 is also able to receive signals from server 230, conveying historical attentiveness information that can be used in the current attentiveness evaluation. In some embodiments, system 220 transmits media signals to one or more of the terminals via exchange 210. It will be clear to those skilled in the art, after reading this specification, how to make and use system 220.

Quality metrics server 230 is a data-processing system that is capable of retrieving attentiveness statistics from database 240, of transmitting those statistics to exchange 210, and of exchanging attentiveness-related signals with system 220. It will be clear to those skilled in the art, after reading this specification, how to make and use quality metrics server 230.

Database 240 is capable of storing statistics related to the attentiveness of one or more call agents, and of retrieving those statistics in response to signals from quality metrics server 230. It will be clear to those skilled in the art, after reading this specification, how to make and use database 240.

As will be appreciated by those skilled in the art, some embodiments of the present invention might employ an architecture for telecommunications system 200 that is different than that of the illustrative embodiment. For example, in some embodiments, interactive voice response system 220 and quality metrics server 230 might reside on a common server. In some other embodiments, quality metrics server 230 and database 240 might not even be present. It will be clear to those skilled in the art, after reading this specification, how to make and use such alternative architectures.

FIG. 3 depicts a flowchart of the salient tasks of interactive voice and video response (IVVR) system 220, in accordance with the illustrative embodiment of the present invention. As those who are skilled in the art will appreciate, at least some of the tasks depicted in FIG. 3 can be performed simultaneously or in a different order than that depicted. In accordance with the illustrative embodiment, IVVR system 220 executes the depicted tasks, which are described below. However, it will be clear to those skilled in the art, after reading this specification, how to make and use alternative embodiments of the present invention, in which a data-processing system other than system 220, such as PBX 210, executes some or all of the described tasks.

For pedagogical purposes, system 220—as well as exchange 210, server 230, and database 240—support a call center, at which human service agents who are stationed at terminals 211-1 through 211-N interact with calling parties who use terminals 201-1 through 201-M to make video calls. However, it will be clear to those skilled in the art, after reading this specification, how to make and use alternative embodiments of the present invention, in which some or all of telecommunications system 200 is used to support communication other than that associated with a call center's operations or to support communication other than video calls, or both. Although an example for a single call is described, it will be clear to those skilled in the art how to concurrently process multiple calls by using the described tasks on each call.

At least some of the tasks described below concern the interval of time after a first call participant, such as a human agent, has become available to handle a video call, which call also involves a second call participant, such as a customer who has called into the call center. It is the first call participant who is monitored via his terminal's video camera, in order to evaluate his attentiveness towards the other call participant or participants, in accordance with the illustrative embodiment. As those who are skilled in the art will appreciate, after reading this specification, one or more additional parties of the call, such as the second call participant, can also be monitored with the video cameras of their own terminals, in order to evaluate their attentiveness.

At task 301, IVVR system 220 receives a real-time image of the first call participant of a video call. Note that the received image is represented as a signal, where the image is received in the form of a video stream. The first call participant is in video communication with the second call participant of the video call. System 220 also receives vocal communication from the first and second call participants, as well as a real-time image of the second call participant.

At task 302, system 220 determines at least one characteristic of the second call participant, such as the participant's gender. In some embodiments, the determination is accomplished by analyzing the received vocal communication, while in some other embodiments the determination is accomplished based on some other information received about the second call participant, such as a database record that indicates gender.

At task 303, system 220 evaluates whether a predetermined condition has been met, where the condition is related to the attentiveness of the first participant. For example, the condition can be related to the first participant having too little eye contact with the other party, having too much eye contact with the other party, staring at a particular part of the screen, and so forth. The evaluation is based on a facial characteristic of the image of the first participant. In accordance with the illustrative embodiment, the facial characteristic comprises eye gaze. There are several well-known techniques available for evaluating eye gaze. For example, eye-gaze evaluation is used in the trucking industry to determine whether a trucker who is currently driving is paying sufficient attention to the road ahead.

In some embodiments, the evaluation is also based on at least one of i) the vocal communication received from the first call participant, ii) the vocal communication received from the second call participant, iii) the gender of the second call participant, and iv) some other characteristic of the second call participant. In some embodiments, the evaluation of whether the predetermined condition has been met is based on whether the second call participant is presently speaking. For example, one rule of the evaluation might be to determine if the first participant is looking at the second participant at least 80% of the time when the second participant is talking, but when the first participant is talking, looking at the second participant only 50% of the time is sufficient.

As those who are skilled in the art will appreciate, the evaluation rules can be adapted over time to learn and account for the types of eye gaze that are acceptable to a viewer and the types that are objectionable. Additionally, in some embodiments, system 220 can track multiple conditions, and, even where each individual condition having been met might be acceptable, system 220 might deem the combined set of conditions having been met as being unacceptable.

At task 304, if the predetermined condition has been met, task execution proceeds to task 305. If not, task execution proceeds back to task 304.

At task 305, system 220 transmits a signal that is based on the predetermined condition having been met. For example, the signal can be a warning (e.g., a tone, a flashing light, etc.) that the first call participant is not maintaining proper eye contact with the second call participant. In accordance with the illustrative embodiment, system 220 transmits the signal to the telecommunications endpoint of the first call participant.

In some alternative embodiments, system 220 transmits the signal to database 240 via quality metrics server 230. Database 240 can be used, for example, to maintain quality metrics about the first call participant and possibly other call participants, with respect to attentiveness. Server 230 can perform data-mining of the information stored on database 240, such as correlating one set of information with respect to another. For example, database 240 can keep track of whether there is a difference in the first participant's attentiveness that correlates with the gender of the second participant. Server 230 can provide those metrics stored on database 240 to one or more interested parties, such as agents stationed at terminals 211-1 through 211-N.

At task 306, system 220 optionally transmits a modified image of the first call participant to the second call participant's endpoint, where the modification is based on the predetermined condition having been met. For example, if it has been determined that the first call participant is being inattentive towards the second participant, system 220 might modify the image to divert the second participant's attention from that fact. The modification might be in the form of i) another image of the first participant being substituted, ii) a blurring of the real-time image, iii) superimposed eyes that appear to be looking at the second participant, or iv) something appearing on the image that is separate from the likeness of the first call participant, such as a flashing light or icon, a message for the second participant to read, and so forth. In some alternative embodiments, system 220 does not transmit the image of the first participant to the second participant because exchange 210 handles the transmission instead.

At task 307, system 220 checks if the video call has ended. If the call has ended, task execution ends. If the call is still in progress, task execution proceeds back to task 301, in order to continue the evaluation of the first call participant.

It is to be understood that the disclosure teaches just one example of the illustrative embodiment and that many variations of the invention can easily be devised by those skilled in the art after reading this disclosure and that the scope of the present invention is to be determined by the following claims.

What is claimed is:

1. A method comprising:
receiving an image of a first call participant of a video call, the first call participant being in video communication with a second call participant of the video call;
evaluating whether a predetermined condition has been met based on a facial characteristic of the image; and
when the condition has been met, transmitting a signal that is based on the condition having been met.

2. The method of claim 1 wherein the signal is transmitted to a telecommunications endpoint of the first call participant.

3. The method of claim 1 wherein the signal is transmitted to a database.

4. The method of claim 1 further comprising receiving vocal communication from the second call participant;
wherein the evaluation of whether the predetermined condition has been met is also based on the vocal communication from the second call participant.

5. The method of claim 4, wherein the evaluation of whether the predetermined condition has been met is based on whether the second call participant is speaking.

6. The method of claim 4, further comprising determining the gender of the second call participant based on the vocal communication;
wherein the evaluation of whether the predetermined condition has been met is also based on the gender of the second call participant.

7. The method of claim 1 further comprising receiving vocal communication from the first call participant;
wherein the evaluation of whether the predetermined condition has been met is also based on the vocal communication from the first call participant.

8. The method of claim 1 wherein the facial characteristic comprises eye gaze.

9. The method of claim 1 further comprising transmitting a modified image of the first call participant to a telecommunications endpoint of the second call participant during the video call, wherein the modified image is based on the evaluation.

10. A method comprising:
receiving i) an image of a first call participant of a video call and ii) vocal communication from a second call participant of the video call;
evaluating whether a predetermined condition has been met based on the eye gaze of the first call participant and the vocal communication from the second call participant; and
when the condition has been met, transmitting a signal that is based on the condition having been met.

11. The method of claim 10, wherein the evaluation of whether the predetermined condition has been met is based on whether the second call participant is speaking.

12. The method of claim 11, further comprising determining the gender of the second call participant based on the vocal communication;
wherein the evaluation of whether the predetermined condition has been met is also based on the gender of the second call participant.

13. The method of claim 10 further comprising receiving vocal communication from the first call participant;
wherein the evaluation of whether the predetermined condition has been met is also based on the vocal communication from the first call participant.

14. The method of claim 11 wherein the signal is transmitted to a telecommunications endpoint of the first call participant.

15. The method of claim 11 wherein the signal is also transmitted to a database.

16. The method of claim 10 further comprising transmitting a modified image of the first call participant to a telecommunications endpoint of the second call participant during the video call, wherein the modified image is based on the evaluation.

17. A method comprising:
receiving i) an image of a first call participant of a video call and ii) vocal communication from the first call participant, the first call participant being in video communication with a second call participant of the video call;
evaluating whether a predetermined condition has been met based on the eye gaze of the first call participant and the vocal communication of the first call participant; and
when the condition has been met, transmitting a signal that is based on the condition having been met.

18. The method of claim 17, wherein the evaluation of whether the predetermined condition has been met is based on whether the first call participant is speaking.

19. The method of claim 18 further comprising receiving vocal communication from the second call participant;
wherein the evaluation of whether the predetermined condition has been met is also based on the vocal communication from the second call participant.

20. The method of claim 19, wherein the evaluation of whether the predetermined condition has been met is based on whether the second call participant is speaking.

21. The method of claim 17 wherein the signal is transmitted to a telecommunications endpoint of the first call participant.

22. The method of claim 17 wherein the signal is transmitted to a database.

23. The method of claim 17 further comprising transmitting a modified image of the first call participant to a telecommunications endpoint of the second call participant during the video call, wherein the modified image is based on the evaluation.
